(19) United States
(12) Patent Application Publication
(10) Pub. No.: US 2006/0278048 A1
(43) Pub. Date: Dec. 14, 2006

(54) Flange wrench

(76) Inventor: David W. St. John, Blackstone, MA (US)

Correspondence Address: Galasso & Associates, LP, P.O. Box 26503, Austin, TX, 78755-0503, US

(21) Appl. No.: 11/446,811

(22) Filed: Jun. 5, 2006

Related U.S. Application Data
(60) Provisional application No. 60/690,082, filed on Jun. 11, 2005.

(51) Int. Cl. B25B 13/48; B25B 13/56

(52) U.S. Cl. 81/176.1

(57) ABSTRACT

A plumbing flange wrench designed to engage with a conventional plumbing flange. The flange wrench includes an elongated body that is configured in a substantially planar manner. The body has a first end and a second end. Positioned at the second end of the body is a handle. Perpendicularly extending from the first end of the body are two connection members designed to releasably secure the flange wrench to a conventional flange by engaging with the apertures proximate the pipe opening. The connection members are centrally and longitudinally mounted to the first end of the body. The flange wrench further includes a coating disposed on the second end.

### PRIORITY UNDER 35 U.S.C. §119(e) & C.F.R. §1.78

This nonprovisional application claims priority based upon the following prior United States provisional patent application entitled: Circulator Flange Wrench, Application No: 60/690,082, filed Jun. 10, 2005, in the name of David W. St. John, which is hereby incorporated by reference for all purposes.

### FIELD OF THE INVENTION

The present invention relates to a hand tool, more specifically but not by way of limitation a flange wrench designed to facilitate the application and removal of a flange with a pipe most commonly found in a heat circulator system.

### BACKGROUND

Numerous individuals, whether through professional trade or hobby, engage in the practice of installation of plumbing systems. These individuals routinely install heating circulator systems comprising of a plurality of conventional plumbing pipes. These pipes are routinely assembled using a plurality of different type of unions. The most common union is a conventional circulator flange. These flanges are usually manufactured from iron or bronze alloy and have two apertures journaled through the flange on opposing sides of the opening for the pipe. Some plumbing ball valves also utilize a flange to facilitate the installation of the ball valve onto a standard pipe.

Currently most individuals utilize a standard adjustable pipe wrench to fasten the circulator flange onto a conventional pipe. There are several problems with the use of the standard adjustable pipe wrench.

One issue with using a standard pipe wrench to fasten a circulator wrench is that flanges can crack when fastening to a pipe. Adjustable pipe wrenches typically do not have tight tolerances and often can only provide minimum grasping ability. These wrenches often slip and individuals apply excessive force when using a standard pipe wrench to fasten a circulator flange. This scenario can commonly result in the cracking or damaging of the flange.

Another issue involved in applying circulator flanges to pipes is space. Heating circulators systems are commonly installed in areas that do not provide significant space for an individual to work on the system. Standard pipe wrenches are often bulky and difficult to manage in confined work areas.

Accordingly there is a need for a circulator flange wrench that is designed to integrally connect with a conventional circulator flange thereby facilitating easier application and reducing the potential of damage of the flange when fastening to the end of a pipe. Further, the circulator flange should be of suitable size in order to be more easily utilized in confined work areas.

### SUMMARY OF THE INVENTION

It is the object of the present invention to provide a circulator flange wrench that integrally mounts to the apertures journaled through the flange on each side of the opening configured to receive a plumbing pipe.

It is a further object of the present invention to provide a circulator flange wrench that is configured to be utilized with all sizes of conventional circulator flanges.

Another object of the present invention is to provide a circulator flange wrench that will not damage a circulator flange when fastening the circulator flange to a pipe.

It is a further object of the present invention to provide a circulator flange wrench that is lightweight and easy to use.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention;

FIG. 2 is a partial cross sectional view taken along A-A of FIG. 1; and

FIG. 3 is an end view of an embodiment of the present invention.

### DETAILED DESCRIPTION

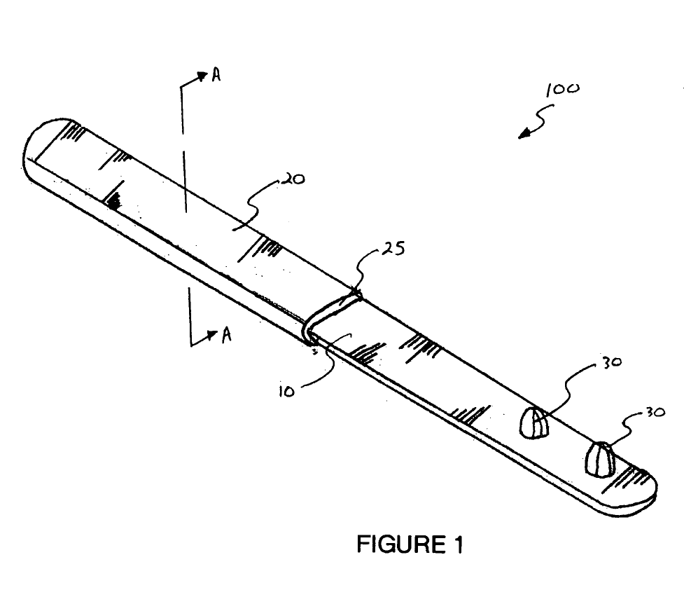

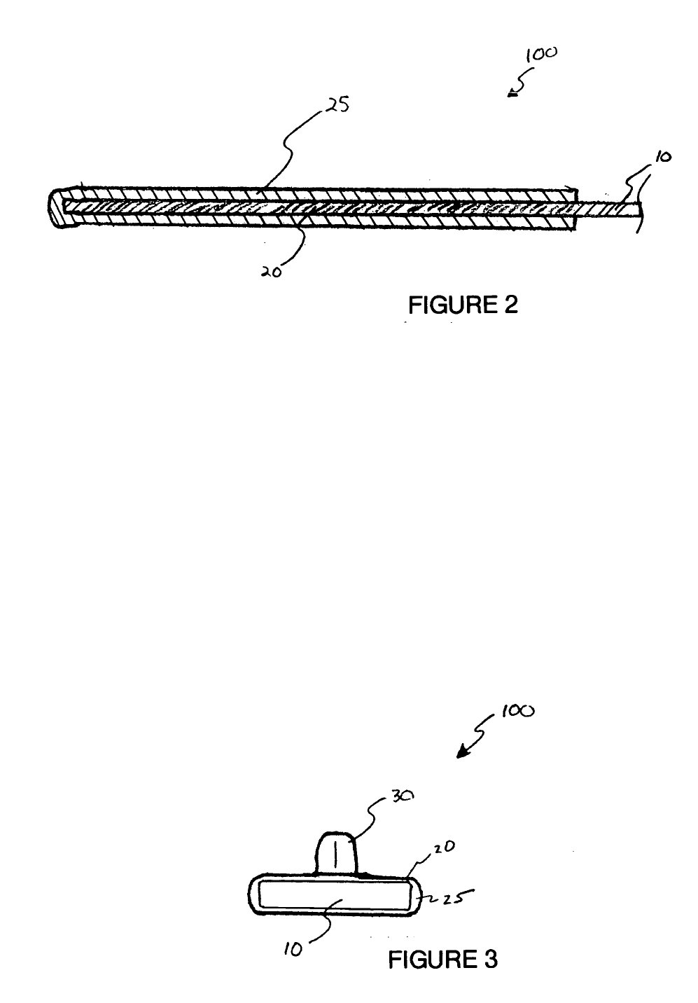

Referring now to the embodiment in FIGS. 1, 2 and 3, and wherein the various elements depicted therein are not necessarily drawn to scale, and wherein like elements are designated with like reference numerals there is illustrated a preferred embodiment of flange wrench 100 constructed according to the principles of the present invention.

The flange wrench 100 comprises a body 10 that is configured in a substantially planar manner. The body 10 is manufactured from a durable rigid material such as but not limited to metal or metal alloy. The body 10 is manufactured in a one piece assembly by conventional methods such as but not limited to casting. Although no specific size of the body 10 is required, good results have been achieved with a body 10 that is approximately twelve inches in length and one inch in width and one-half inch thick.

Those skilled in the art will recognize that the body 10 could be manufactured from numerous different types of suitable rigid materials. It should further be recognized that the body 10 or at least a portion thereof could be manufactured in a plurality of different shapes to enhance the ergonomics of the flange wrench 100. Furthermore, although the body is illustrated in the drawings submitted herewith as having rounded ends, those skilled in the art should recognize that these ends could be numerous different shapes.

Body 10 includes a handle portion 20 at one end. The handle portion 20 functions as the leverage point in utilizing the flange wrench 100 by a user. The handle portion 20 of body 10 is manufactured from a suitable durable material such as metal or metal alloy.

Substantially disposed on handle portion 20 is coating 25. The coating 25 functions to provide a non-slip grip for the user of the flange wrench 100. The coating 25 is secured to the handle portion 20 by suitable conventional methods such as friction or chemical adhesion. The coating 25 is manufactured from a suitable durable and resilient material such as but not limited to rubber or plastic.

Two connection members 30 are mounted to body 10 at an end opposite of handle portion 20. The connection members 30 are centrally mounted along the same longitudinal axis opposite of the handle portion 20 and generally extend outward there from. In this embodiment the connection members 30 are cylindrical in shape and are perpendicular to the body 10. However, the size and shape diameter of the connection members 30 can vary in shape such that they are of sufficient size and diameter to releasably secure with the apertures of the target plumbing flange mounted on opposing sides of the pipe opening. Those skilled in the art will recognize that conventional plumbing flanges are manufactured in sizes, three-quarters of an inch, one inch, one and a quarter inch and one and a half inch in diameter. The connection members 30 are manufactured from a suitable durable material such as but not limited to metal or metal alloy.

The connection members 30 are secured to the body 10 by conventional methods such as but no limited to welding or chemical adhesion. It is further contemplated within the scope of the present invention that the connection members 30 and the body 10 could be cast manufactured as a one piece assembly. Furthermore, it is contemplated within the scope of the present invention that the connection members 30 could be movably mounted to the body 10 in order to provide adjustability to engage with a plurality of different size plumbing flanges. The connection members 30 are designed to engage with the two apertures that are present on a conventional plumbing flange on opposing sides of the opening for the pipe. The connection members 30 are mounted on the body 10 such that the spacing therebetween is consistent with the spacing between the two apertures journaled through a standard plumbing flange on opposing sides of the pipe opening.

While no specific length is required for the connection members 30, good results have been achieved with connection members that are approximately one-half inch in length. It is contemplated within the scope of the present invention that the flange wrench 100 could be manufactured in several different embodiments having the connection members 30 spaced to properly engage with the apertures of a plurality of standard flange sizes. More specifically but not by way of limitation, the flange wrench 100 could be manufactured to engage with apertures journal through standard plumbing flanges that are one inch, one and a quarter inches and one and a half inches. Those skilled in the art should recognize that numerous different shapes of the connection members 30 could be utilized to achieve the function suggested herein. More specifically but not by way of limitation, the connection members 30 could be conical in shape.

A description of the operation of the flange wrench 100 is as follows. In use, a user will grasp the handle portion 20 of the body 10 and place the flange wrench 100 adjacent to the desired plumbing flange. The user will align the connection members 30 with the apertures present on opposite sides of the pipe opening on the flange. The user will engage the connection members 30 into the apertures of the plumbing flange thereby releasably securing the flange wrench 100 to the plumbing flange. The user will apply a force in a rotational direction either clockwise or counterclockwise depending on whether the desired task is to remove or secure the plumbing flange to the pipe. Once the desired task is accomplished that user releases the flange wrench 100 from the plumbing flange.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A wrench designed to engage with a standard size plumbing flange comprising:
a body, said body having a first and a second end, said body being configured in a substantially planar manner;
at least two connection members, said at least two connection members centrally mounted to said first end of said body in axial alignment, said at least two connection members for engaging the plumbing flange; and
said second end of said body configured to be a handle, said handle being distally located from said connection members.

2. The wrench as recited in claim 1, wherein said connection members are generally cylindrical in shape.

3. The wrench as recited in claim 2, and further including a coating, said coating substantially disposed on said handle.

4. The wrench as recited in claim 3, wherein said coating is manufactured from at least one of at least rubber and plastic.

5. The wrench as recited in claim 4, wherein each of said at least two connection members are approximately one-half inch in length.

6. The wrench as recited in claim 5, wherein said body is approximately twelve inches in length, one inch in width, and one-half inch thick.

7. A plumbing flange wrench designed to engage with a conventional plumbing flange comprising:
a body, said body being elongated and configured in a substantially planar manner, said body having a first end and a second end;
a plurality of connection members, at least two of said plurality of connection members centrally mounted in axial alignment proximate said first end of said body, each of said plurality of said connection members being perpendicular to said body and extending outward there from, said connection members being of suitable shape for engaging said plumbing flange; and
a handle at said second end of said body.

8. The wrench as recited in claim 7, and further including a coating, said coating substantially disposed on said handle.

9. The wrench as recited in claim 8, wherein said plurality of connection members are cylindrical in shape and are approximately one half inch in length.

10. The wrench as recited in claim 9, wherein said body is approximately twelve inches in length, one inch in width, and one-half inch thick.

11. The wrench as recited in claim 10, wherein said body is manufactured from a metal.

12. The wrench as recited in claim 11, wherein said first end and said second end of said body are generally rounded in shape.

13. The wrench as recited in claim 12, wherein said coating is manufactured from rubber.

14. A plumbing flange wrench designed to engage with the apertures opposite the pipe opening on a conventional plumbing flange comprising:
a body, said body being configured in a substantially planar manner, said body having a first end and a second end;
two connection members, said connection members centrally mounted in axial alignment proximate said first end of said body, said connection members being perpendicular to said body and extending outward there from, said connection members being cylindrical in shape, said connection members for engaging the apertures proximate the pipe opening of a conventional plumbing flange; and
a handle at the second end of the body.

15. The plumbing flange wrench as recited in claim 14, and further including a coating, said coating being substantially disposed over said handle.

16. The plumbing flange wrench as recited in claim 15, wherein said first end and said second end are rounded in shape.

17. The plumbing flange wrench as recited in claim 16, wherein said body is approximately twelve inches in length, one inch in width, and one-half inch thick.

18. The plumbing flange wrench as recited in claim 17, wherein said wrench is manufactured from metal.

19. The plumbing flange wrench as recited in claim 18, wherein said connection members are approximately one-half inch in length.

20. The plumbing flange wrench as recited in claim 19, wherein said coating is manufactured from rubber.
